(19) United States
(12) Patent Application Publication
(10) Pub. No.: US 2014/0196432 A1
(43) Pub. Date: Jul. 17, 2014

(54) THE TESLA TWIN TURBINES COMBUSTION ENGINE MODULE

(71) Applicants: Vinh Minh Glisttenmeer Lam, HAYWARD, CA (US); ETHAN LAM, FREMONT, CA (US); MEGAN LAM, Fremont, CA (US); VICTOR LAM, Fremont, CA (US)

(72) Inventors: Vinh Minh Glisttenmeer Lam, HAYWARD, CA (US); ETHAN LAM, FREMONT, CA (US); MEGAN LAM, Fremont, CA (US); VICTOR LAM, Fremont, CA (US)

(21) Appl. No.: 13/741,313

(22) Filed: Jan. 14, 2013

(51) Int. Cl. F02C 3/14

(52) U.S. Cl. CPC F02C 3/14
USPC 60/39.15

(57) ABSTRACT

A new type of engine module is described based on the Tesla turbine. Our Tesla Twin Turbines Combustion Engine Module comprises of two Tesla turbines welded together, forming a combustion chamber in between. The combustion chamber includes an air-fuel mixture inlet and an ignition inlet. Fuel-air mixture is injected through the air-fuel inlet into the combustion chamber which is ignited by an ignition device. The high temperature combustion gas flow in opposite directions across 2 stacks of evenly spaced smooth parallel discs, transferring energy into rotating the discs via the mechanism of boundary layer laminar flow interaction. The pair of rotating stacks of discs rotates a pair of rods. The gas exits through exhaust holes or openings adjacent to the pair of rods. The rotating rods can be used to drive generators or do useful works.

### FIELD OF THE INVENTION

The present invention relates to the field of combustion engine constructed from evenly spaced stacks of smooth parallel discs that utilizes the mechanism of laminar boundary layer flow interaction to transfer the energy from the combustion gas to the smooth rotating discs which turn a pair of rotating rods.

### BACKGROUND OF THE INVENTION

### Description of the Prior Art

References Cited:

| Patent Number | Date | Inventor | Field |
|---|---|---|---|
| 1,013,248 | Jan. 2, 1912 | Wilkinson et al | 415/90 |
| 1,061,206 | May 6, 1913 | Tesla | 415/90 |
| 1,061,142 | May 6, 1913 | Tesla | 415/90 |
| GB186083 | Mar. 24, 1921 | Tesla | 415/90 |
| 3,010,281 | Nov. 28, 1961 | Ceirenka et al | 60/39.37 |
| 3,007,311 | Nov. 7, 1961 | Amero et al | 415/90 |
| 6,399,020 | Jun. 4, 2002 | Lee et al | 420/537 |
| 6,503,067 | Jan. 7, 2003 | Palumbo | 415/90 |
| 6,779,964 | Aug. 24, 2004 | Dial | 415/1 |
| 7,241,106 | Jul. 10, 2007 | Aviña | 415/90 |
| US 2010/0107647 A1 | Oct. 29, 2009 | Bergen | 60/722 |
| 7,632,061 | Dec. 15, 2009 | Neeb et al | 415/90 |

There is a need in our world for a new kind of engine that can utilize clean burning combustible fuel. Moreover, such an engine must be versatile enough to be able to utilize many different kinds of fuel. The engine must also be robust enough to utilize fuel sources with high amount of impurities. The engine must also be simple enough to be built affordably.

Recognizing these needs, Nicola Tesla invented the Tesla turbine in his 1913 U.S. Pat. No. 1,061,206. Almost at the same time, Wilkinson et al also invented something very similar to a Tesla Turbine in his 1912 U.S. Pat. No. 1,013,248. These types of turbine utilize the effect of boundary layer laminar flow on smooth parallel evenly spaced discs to transfer the energy or momentum from the flowing gases or fluid to the discs. The high temperature flowing gases or fluid rotate the discs which in turn rotate a rod connected to the center of the discs. The rod can then be used to drive generators or do other kind of useful works. In his 1921 British patent GB186083, Tesla describes his vision of the use of his Tesla turbine as the engine that will be able to meet the energy needs of the future. Tesla describes the versatility of his Tesla turbine, its robustness and its ease of manufacturability. For a century since his invention, people have experimented with different variations of the Tesla turbine as an engine. In their 1961 patent, U.S. Pat. No. 3,007,311, Amero et al design an axial intake and exhaust turbine, with the combustible gas generated from an external source. Also in 1961, in their patent, U.S. Pat. No. 3,010,281, Ceirenka et al design a toroidal combustion chamber around an impeller turbine. This is an early example where the combustion chamber is a toroidal chamber surrounding the turbine. In his 2004 patent, U.S. Pat. No. 6,779,964, Dial disclosed a toroidal chamber surrounding the Tesla turbine parallel discs which is very similar to the 2009 patent application by Bergen, US 2010/0107647 A1, who disclosed a Tesla Gas Turbine with the toroidal chamber surrounding a Tesla turbine. Over a century, we see the evolution of the Tesla turbine from one where the gas is generated from an external combustion source to one where the combustion chamber is toroidal and surround the Tesla turbine.

Despite many improvement over the century, problems still remain in the prior arts. The prior arts utilize an external combustion source which makes for a very bulky Tesla turbine system. In Nicola Tesla British patent, the entire system of combusting gases connected to the Tesla turbine would take up an entire room. Amero et al design a system where the combustion gases are generated externally, which also lead to a bulky system. Bergen designs his toroidal combustion chamber to surround the Tesla turbine, but it is still external to the Tesla turbine, which remains bulky because the toroidal combustion chamber would necessarily increase the diameter of the entire machine beyond the diameter of the Tesla turbine. Furthermore, a toroidal combustion chamber surrounding a Tesla turbine is complicated to manufacture and assemble.

### SUMMARY OF THE INVENTION

The objective of our invention is to push this evolution of the Tesla turbine a step further, by incorporating the combustion chamber inside the Tesla turbine. This improvement will provide a number of benefits. By incorporating the combustion chamber inside the Tesla turbine, this improvement simplified the design and manufacturability of the Tesla turbine significantly. By having the combustion gases as close as possible to the Tesla turbine discs, this improvement increase the efficiency of the energy transfer from the combustion gases to the rotating discs. By designing the Tesla turbine to be as simple as possible allows the Tesla turbine to be coupled to one another into an array of Tesla turbines to increase the amount of torque generated. These benefits will be described in detail later.

This objective can be attained by our invention, the Tesla Twin Turbines Combustion Engine Module, which is designed to be modular so that an array of these modules can be coupled to one another to create a more powerful Tesla Twin Turbines Combustion Engine Array. In brief summary, the module comprises of two identical Tesla turbines welded together along the air-flow intake interfaces to create a chamber that will serve as the combustion chamber. An air-fuel inlet and an ignition inlet are channeled into the combustion chamber. The air-fuel mixture, which can be varied in composition and amount, and which can increase or decrease or injected continuously or alternating between fuel or air flow is injected into the chamber, where an ignition device, such as a sparkplug inserted into the ignition device inlet would ignite the air-fuel mixture into a combustion gas which flow in both directions to drive the two opposite stacks of parallel discs whose rotation drive the connecting rods. These rotating rods can be coupled to a generator to produce electricity or be coupled to a transmission gear system to drive the wheels of an automobile. Because of the compact size of our module, it can be easily transported or incorporated into automobiles as engines. In summary, our invention provides a novel and significant improvement over the prior arts in terms of ease of manufacturability, higher efficiency, and smaller compact size.

### BRIEF DESCRIPTION OF THE FIGURES

FIG. 1 shows an isometric view of our Tesla Twin Turbines Combustion Engine Module. The shaded transparent view allow for greater understanding of the invention.

FIG. 2 shows another isometric view of our module.

FIG. 3A shows a shaded transparent top view of the module.

FIG. 3B shows a top view of the module with a cross section view line.

FIG. 4 shows the cross section view.

FIG. 5A shows various isometric views of the individual Tesla turbine.

FIG. 5B shows a cross sectional view of the individual Tesla turbine.

FIG. 6A shows isometric views of the pairs of stack of even spaced parallel discs.

FIG. 6B shows the edge view of the stack of parallel discs.

FIG. 7A shows an isometric view of an array of modules, a Tesla Twin Turbines Combustion Engine Array.

FIG. 7B shows another isometric view of the engine array.

### DESCRIPTION OF THE PREFERRED EMBODIMENT

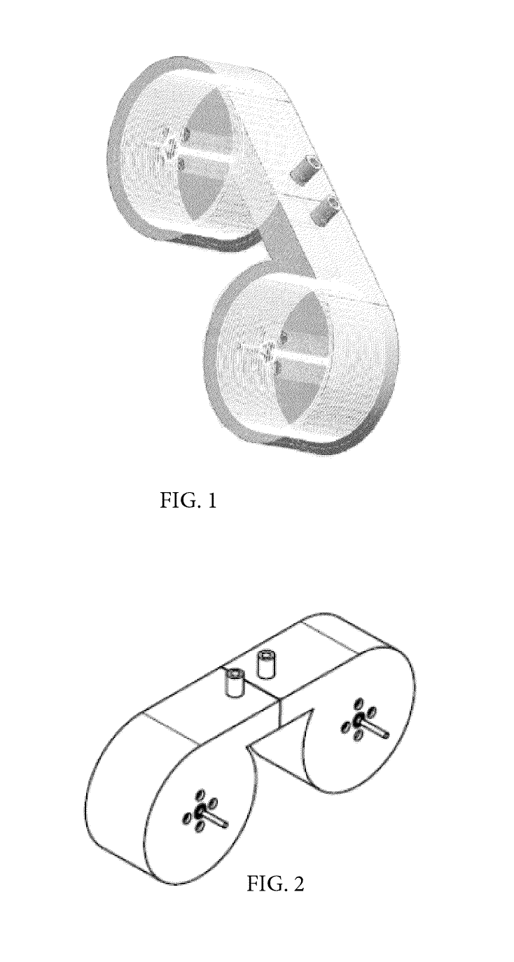

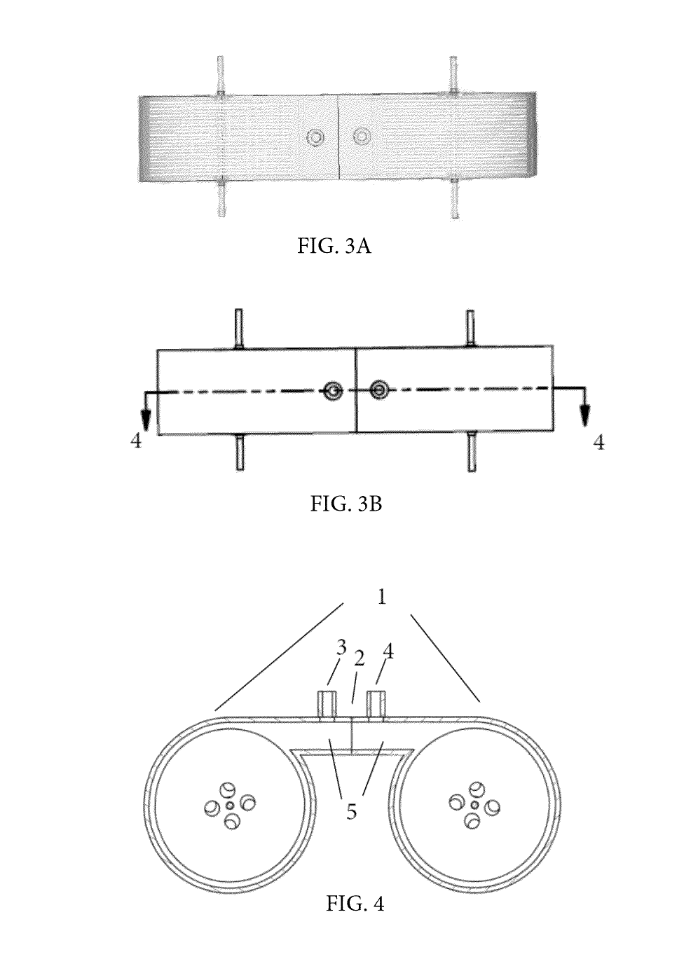

We will describe in detail our invention, the Tesla Twin Turbines Combustion Engine Module, which will be called the “module” from here on. FIG. 1 shows a shaded transparent isometric view of the module, showing the inner mechanism of our module. FIG. 2 shows another isometric view of the module with the general shape and outer surface clearly depicted. FIG. 3A shows a transparent and shaded top view of the module. In this view, we can also see the inner mechanism of the module. FIG. 3B shows the top view with a view line showing where the cross section will be depicted in FIG. 4. The cross section view in FIG. 4 shows two Tesla turbines 1 being welded along the combustion chamber interface 2. The air-fuel mixture inlet 3 is channeled into the combustion chamber 5. The ignition inlet 4 is also channeled into the combustion chamber 5.

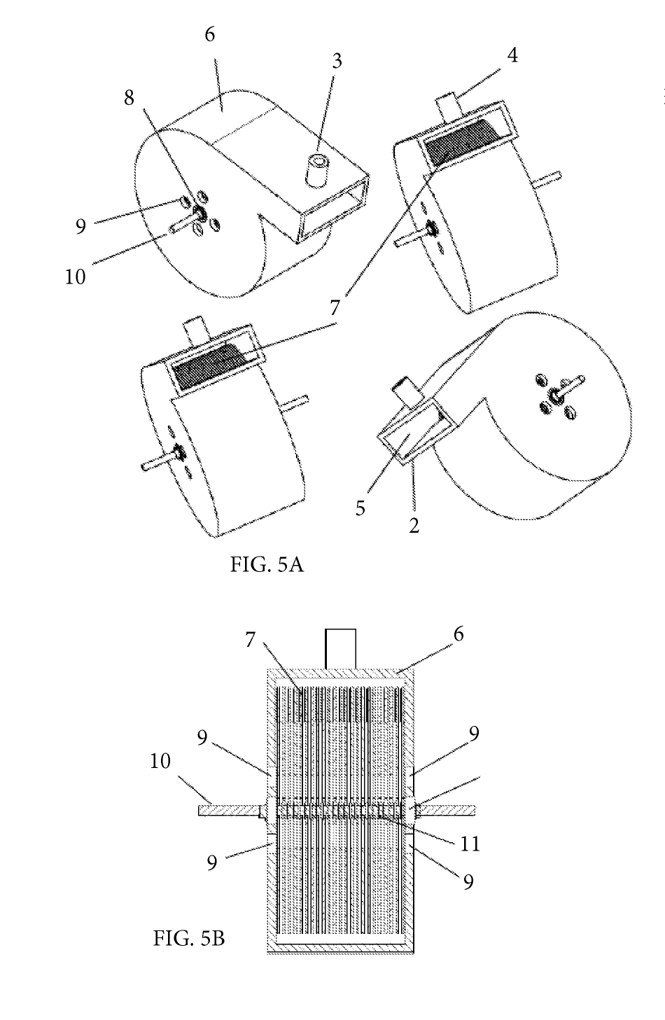

FIG. 5A shows individually the pair of Tesla turbines. The air-fuel inlet 3 is channeled through the metallic housing 6 which encloses the two stacks of evenly spaced parallel discs 7. At the side faces of the housing are openings, holes 9, which are the exhaust openings for the combustion gas exiting the turbine after the gas has transferred its energy to the parallel discs 7, which are attached to and rotate rod 10. Rod 10 is coupled to the housing by a pair of bearings 8. The two Tesla turbines are welded together along the combustion chamber interface 2, forming a chamber 5 that function as a combustion chamber for receiving the combustible material from the air-fuel mixture inlet 3, which is ignited by the ignition device in the ignition inlet 4.

FIG. 5B shows in detail the stack of parallel discs 7 within the housing 6. The rod 10 is attached concentrically through the center of the stack of parallel discs. Spacers 11, which are metal O-rings, evenly separate the parallel discs apart, and serve as a medium to attach the discs to the rod by welding the discs to the spacers O-rings, and welding the O-rings to the rod. The exhaust openings on the side faces of the metal housing, holes 9, are concentric and adjacent to the rod 10. The combustion gas flows from the edges of the discs to the central exhaust openings, holes 9, where the gas exits. The gas flows in a circularly spiraling manner and transfers their momentum to the discs by the effects of boundary layer laminar flow. This momentum transfer, from the energy of the gas to the discs, rotates the discs, which in turns rotates the rod.

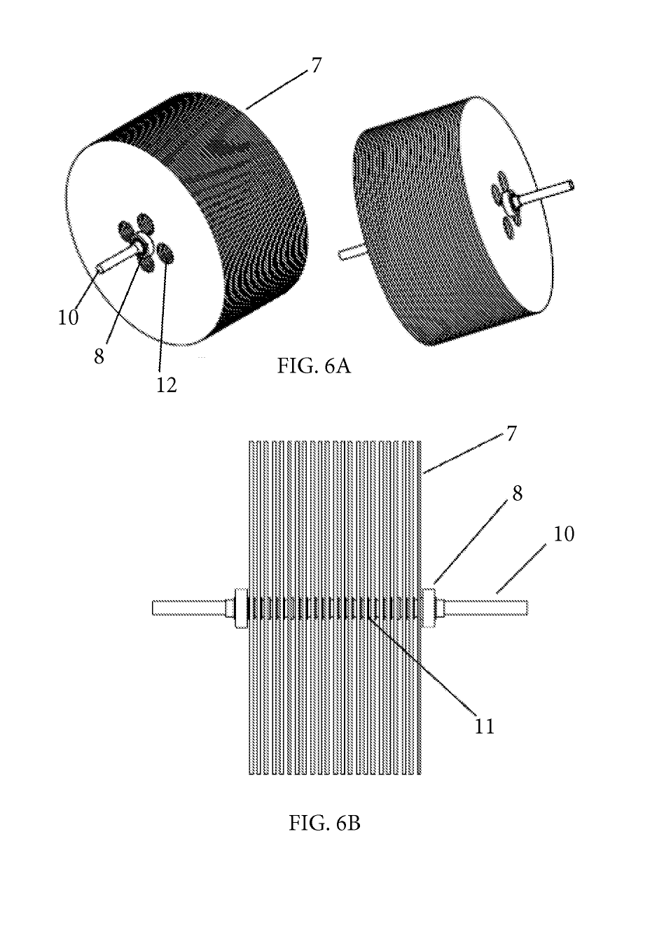

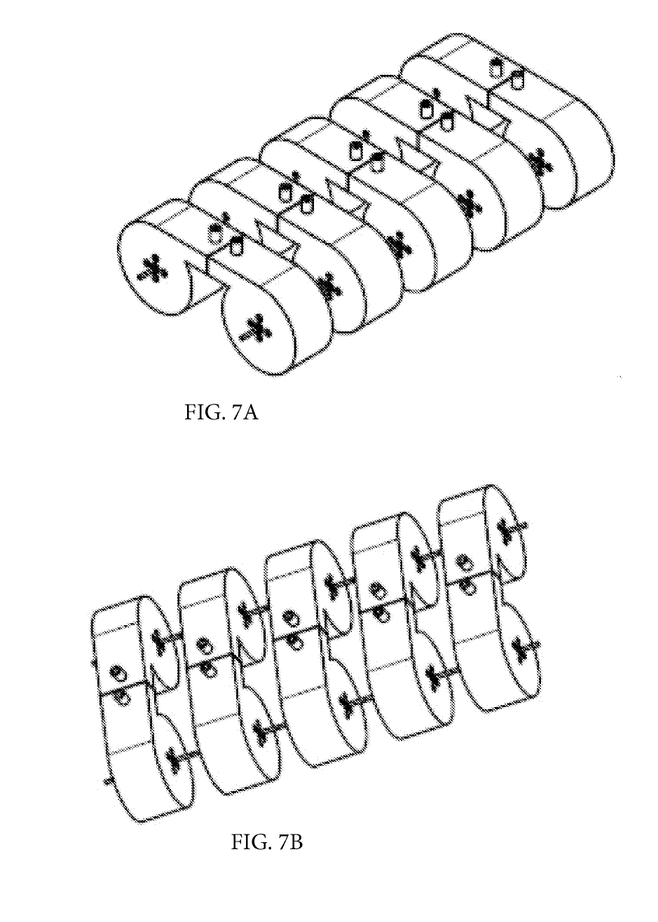

FIG. 6A shows in detail isometric views of the stacks of evenly spaced parallel discs 7 connected to the rod 10. There are exhaust openings on the discs, holes 12, where the exhaust gas exits after flowing circularly and spiraling from the edge of the discs. The gas exiting holes 12 on the discs traverses through exhaust openings, holes 9, on the side faces of the metal housing to the external environment.

FIG. 6B show in edge view the stack of evenly spaced parallel discs 7 connected to rod 10. The rod 10 is coupled to the housing by a pair of bearings 8. The discs 7 is evenly spaced apart by spacers, metal O-rings 11, which serve as a medium to weld the discs to the O-rings, and to weld the metal O-rings to the rod.

Our module is compact and can be assembled together into an array because of its modular nature. The modules can be coupled to each other by coupling the ends of the rods together. Those skilled in the mechanical arts will find many different ways to couple the rods together. For greater flexibility in assembling the array of modules, universal joints can be used to couple the rods together. FIG. 7A shows an isometric view of an array of modules coupled together along their rods. FIG. 7B shows another isometric view of such an array. The advantage of our module can be clearly seen when assembled into an array. The compactness and modularity of our modules allow it to be assembled easily into a compact array of modules, thereby increasing the total torque generated. Tesla turbines are capable of rotating at extremely high speed. However, the torque generated by a single turbine is relatively small. The modularity and compact size of our invention allow the modules to be assembled into an array of any number of modules, producing a torque that can rival any piston engine.

In the past century, development of the Tesla turbine as a useful machine has been hampered by the lack of progress in material sciences. Many believed that one major reason why the Tesla turbine has not been widely adopted result from the lack of suitable material that can withstand high temperature and high rotational speed without warping. Parallel discs are prone to warp at high temperature and high rotational speed. In the past, to overcome this problem, parallel discs were made very thick, using steel or iron, resulting in a very bulky and heavy Tesla turbine, which limited their application in many areas. Currently, material advances have progressed to the point where this problem can be solved with light weight material that can withstand high temperature and high rotational speed without warping.

Our preferred material to use for constructing our module is a new kind of alloy developed within the past decade, and described in a 2002 patent, U.S. Pat. No. 6,399,020, by Lee et al, who described an aluminum alloy with 14% Si, which produced an alloy that can withstand high temperature without warping. This alloy is also known as the NASA aluminum alloy and is used commercially in a wide range of high temperature application requiring thermal stability and high strength. For example, this alloy has been used to produce pistons for use in automotive piston engines. We will use this Al-Si alloy to produce the stacks of parallel discs as well as the metal housing and rotating rods for our modules. The advantage of this Al-Si alloy is its lightweight, high strength, and thermal stability at high temperature. To enhance the alloy thermal stability and strength at high temperature, we prefer to use an aluminum alloy with 18% Si.

We claim a new kind of machine, called the tesla twin turbines combustion engine module, also known as the “module:”

1. A module comprising:
two Tesla turbines coupled together;
creating a chamber in between the said two Tesla turbines, with said chamber functioning as the combustion chamber located between the said two Tesla turbines;
with an air-fuel inlet which channels into said combustion chamber, which injects a variable mixture of air and fuel in variable amount through said air-fuel inlet channel into said combustion chamber;
an ignition device inlet which channels into said combustion chamber, where an ignition device will ignite the air-fuel mixture inside said combustion chamber, with the resulting combustion gas flowing in opposite directions into the said two Tesla turbines transferring the energy and momentum of the gas to the stacks of evenly spaced parallel discs through the interaction of boundary layer laminar flow which rotates the stacks of parallel discs;
exhaust holes on said discs which are located concentric to said discs adjacent to the center of said discs, where said combustion gas then exit through said exhaust holes;
a metal housing enclosing said two turbines;
exhaust holes on said metal housing located concentrically around said rods, where said exhaust gas travel through said exhaust holes into the external environment;
two stacks of evenly spaced parallel discs which are enclosed by said two metal housings of said two Tesla turbines, and which said discs are connected to a rod through the center of said discs;
said two rods which are rotated by the said two stacks of evenly spaced parallel discs.

2. An array of modules comprising:
a multiple of said modules of claim 1 connected together by universal joints;
said universal joints connecting the rotating rod of one module to the rotating rod of the adjacent module, resulting in an array of modules connected in series;
with a combined torque generated by said array of modules that is multiple times the torque generated by a single module.

3. The module of claim 1, with components to be constructed from metallic alloys comprising of:
an aluminum alloy with 18% Si, also known as the NASA aluminum alloy.
